(19) United States
(12) Patent Application Publication
(10) Pub. No.: US 2009/0144112 A1
(43) Pub. Date: Jun. 4, 2009

(54) COMPUTER SYSTEM MANAGEMENT CENTRAL SCHEDULE FOR BUSINESS DOWNTIMES

(76) Inventor: KLAUS ESCHENROEDER, Karlsruhe (DE)

Correspondence Address: SAP AG, 3410 HILLVIEW AVENUE, PALO ALTO, CA, 94304, US

(21) Appl. No.: 12/324,928

(22) Filed: Nov. 28, 2008

Related U.S. Application Data
(60) Provisional application No. 60/991,149, filed on Nov. 29, 2007.

(51) Int. Cl. G06Q 10/00; G06F 7/06; G06F 17/30; G06N 5/02

(52) U.S. Cl. 705/7; 707/3; 707/201; 706/59; 707/E17.014; 707/E17.044; 707/E17.005

(57) ABSTRACT

A method and a system are described that involve a schedule for central downtime planning. In one embodiment, the method includes creating a plurality of entries in a downtime schedule, wherein the downtime schedule can be a central downtime schedule, residing on a managing system, or a local downtime schedule, residing on a managed system. The method further includes synchronizing the central downtime schedule with the local downtime schedule. Finally, the method includes querying the downtime schedule to retrieve downtimes of the managed system.

In one embodiment, the system includes a central managing system and a set of managed systems that are connected with the central managing system via a Web service. The system also includes a central downtime schedule that stores a plurality of entries, wherein the central downtime schedule resides on the central managing system. The system further includes a synchronization service that synchronizes the plurality of entries stored in the central downtime schedule with a local downtime schedule residing on each of the set of the managed systems.

### CROSS REFERENCE TO RELATED APPLICATION

This application claims priority from Provisional Application No. 60/991,149 entitled “Software based central computer system management schedule for business downtimes” and filed on Nov. 29, 2007.

### FIELD OF INVENTION

Embodiments of the invention relate generally to the software arts, and, more specifically, to a software-based central schedule for computer system management of business downtimes.

### BACKGROUND

In the business world, computer systems must be occasionally locked for productive use or shut down for maintenance. This is called a “downtime” of a system. The term is commonly applied to servers and networks, but it may affect any kind of a business system such as: medical informatics, banks, airlines, e-commerce, and so on. More generally, the term “downtime” is used to refer to periods of time when a system is unavailable and fails to perform its primary function. There are two main types of downtimes: planned and unplanned. The unplanned downtime is unannounced and may be a result of a software bug, human error, equipment failure, malfunction, power failure, and so on. Unplanned downtimes can be extremely costly to an organization. The source of unplanned downtimes can be in any of the layers that make up the complete software and hardware environment: front-end and middleware services for connection to the Web, system services of the individual application components, underlying hardware and software services, such as the database services, network and operating system services, and various hardware services, including servers, disks, memory, and uninterruptible power supply (UPS).

The planned downtime is a result of a planned activity by the system owner or service provider. Such activities can include changes or upgrades of the system and they are often scheduled as maintenance windows. Some of the possible causes for a planned downtime are: hardware maintenance, upgrades to new releases, database reorganization, database backup, and so on. The planned downtimes are typically defined in a service level agreement (SLA). The SLA defines the attributes for service products (for example, maintenance, Hotline) that have been agreed upon with the customer in service contracts. The SLA confirms different parameters, such as maintenance windows, response time, availability time, and system availability. The service provider of a SLA must deliver availability reports for the managed system including maintenance windows. Even if the system availability can be automatically recorded, the creation of such reports will be very difficult because planned downtimes and unplanned downtimes cannot easily be distinguished. Therefore, the reports must be corrected manually and thus, slowing down the availability reporting from the service provider and performing inaccurate downtime planning of the managed system.

Another issue that can arise during business downtimes is handling alerts. Typically, computer systems are monitored by a separate software-based monitoring solution that detects exceptional situations and generates alerts that have to be processed by a human administrator. During a business downtime, most alerts can be ignored. To reduce total cost of ownership (TCO) for system administration, it is important to suppress all alerts during planned downtimes.

### SUMMARY

A method and a system that involve a schedule for central downtime planning are described. In one embodiment, the method includes creating a plurality of entries in a downtime schedule, wherein the downtime schedule can be a central downtime schedule, residing on a managing system, or a local downtime schedule, residing on a managed system. The method further includes synchronizing the central downtime schedule with the local downtime schedule. Finally, the method includes querying the downtime schedule to retrieve downtimes of the managed system.

In one embodiment, the system includes a central managing system and a set of managed systems that are connected with the central managing system via a Web service. The system also includes a central downtime schedule that stores a plurality of entries, wherein the central downtime schedule resides on the central managing system. The system further includes a synchronization service that synchronizes the plurality of entries stored in the central downtime schedule with a local downtime schedule residing on each of the set of the managed systems.

### FIGURES

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of an embodiment for downtime planning using a schedule.

FIG. 2 is an embodiment of a data model for downtime planning.

FIG. 3 is an embodiment of a package with APIs for editing and querying the downtime schedule.

FIG. 4 is a flow diagram of an embodiment for central downtime planning.

### DETAILED DESCRIPTION

Embodiments of the invention relate to a method and a system for planning business downtimes via a software-based central schedule for computer system management. The central schedule is designed to store information about system management periods that may or may not lead to a business downtime. The schedule establishes a relation between management tasks, monitoring state, planning state, and management periods. The schedule can be basis for automating many downtime related tasks such as: suppressing undesired alerts, generating availability reports, informing users for upcoming downtimes, preventing the start of long running jobs, announcing planned system upgrades, documenting high availability periods, and so on.

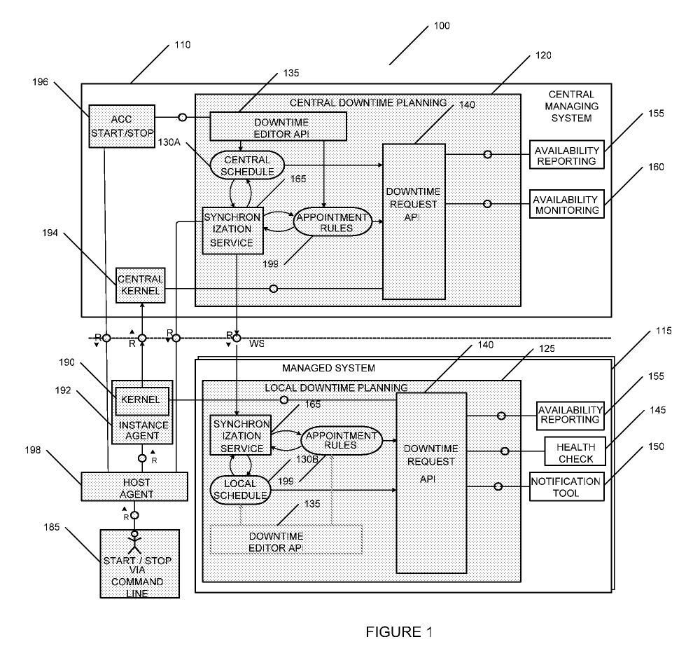

FIG. 1 is a block diagram of an embodiment for downtime planning using a schedule. Diagram 100 includes a central managing system 110 and a managed system 115. The central managing system 110 may be located remotely or on the same physical machine as the managed system 115. In an embodiment, a service provider may provide central monitoring services via central managing system 110 to a customer. The central managing system 110 will monitor and manage a number of managed systems of the customer. This can be negotiated in a service level agreement (SLA) between the service provider and the customer. The central managing system 110 may include a central downtime planning unit 120. For correct planning of the downtimes, a local downtime planning unit 125 is included in managed system 115.

The central managing system 110 includes a central downtime schedule 130A. The managed system 115 includes a local downtime schedule 130B. The local schedule 130B stores information about system management periods of managed system 115 that may lead to planned or unplanned downtimes. The central schedule 130A stores such information for all managed systems connected with the central managing system 110. Downtimes for the managed systems, such as managed system 115, are planned in the downtime schedule 130A of the central system and provided to the respective managed system 115. Applications in both, the managing system 110 and the managed system 115, have access to the information in the downtime schedules. The downtime schedules, 130A and 130B, can be accessed and edited by application programming interfaces (APIs) such as downtime editor API 135 and downtime request API 140.

Central managing system 110 and managed system 115 may contain additional applications that can benefit from the schedules 130A and 130B. Managed system 115 may include an alert engine such as health check 145 unit. The alert engine can use the information stored in the local schedule 130B about upcoming downtimes to decide when to suppress unnecessary alerts. Managed system 115 may also include a notification tool 150, which using local schedule 130B may notify users of the system or contact persons in case of a scheduled or unscheduled downtime. The notification tool 150 may also be used for other purposes such as to notify users of a business transaction that the transaction is being unavailable, as this unavailability is not due to a system downtime.

Managed system 115 and central managing system 110 may include an availability reporting 155 unit. The availability reporting 155 uses the downtime schedule, central or local, to determine the unavailability of managed systems, such as managed system 115, in preparing availability reports. Additional unit that may be included in the central managing system 110 is availability monitoring 160. Availability monitoring is based on kernel (system low level data) availability records. The availability monitoring 160 unit uses the central schedule 130A to evaluate if a particular unavailability period is part of a planned downtime. Health check for availability monitoring is based on the kernel availability records as well. The downtime schedule is used to determine if a detected unavailability could lead to an incident.

System downtimes are planned in the central managing system 110, but they also have to be available locally on all managed systems, such as managed system 115. Therefore, the central managing system 110 and the managed systems include a synchronization service 165 component. The synchronization service 165 component synchronizes the information stored in the central downtime schedule 130A with the local downtime schedule 130B.

Unplanned downtimes can be initiated on managed system 115, if the managed system 115 is stopped or restarted in a controlled way. The managed system 115 can be stopped and started from an operating system (OS) console, such as command line console 185. Using the command line console 185, monitoring status of the managed system 115 can be set. The monitoring status is sent to the local Kernel Management System (KMS) 190 of the instance agent 192. The monitoring status is then forwarded to the central Kernel Management System 194, which is assumed to run on the managing system 110. Thus, the local KMS 190, the central KMS 194, and the central and local Health Check 145 can access the monitoring status during downtime. Once the managed system 115 has been started, the monitoring status must be reset.

In an embodiment, the managed system 115 can be operated from a remote console such as Adaptive Computing Controller (ACC) 196. Using a Web service, the ACC 196 may send a request to a host agent 198 to start and stop the managed system 115 and to set the monitoring status. Downtimes can be specified by a start time and end time or by a complex rule using appointment rules 199 service. Appointment rules 199 allow specifying and connecting periodical reoccurrences of downtimes (e.g., every first Friday each month).

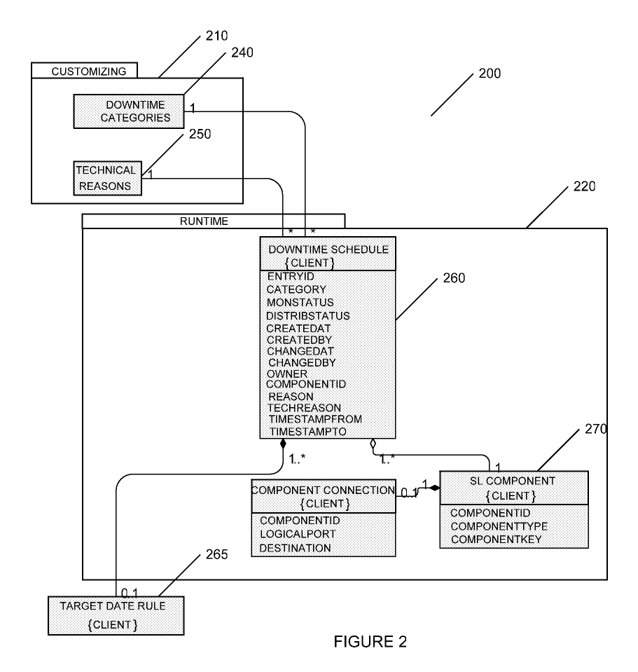

FIG. 2 is a data model 200 for downtime planning. Generally, a data model is an abstract model that describes how data is represented and accessed. Data models define data objects and relationships among the data objects. Data model 200 presents the data model layer of the downtime planning functionality. Data model 200 may include: customizing 210, runtime 220, and caching tables 230. Customizing 210 includes data objects of the downtime planning that can be customized, for example, by a system administrator. Such data objects may be categories 240 and technical reasons 250. Downtime categories 240 specify the different types of a downtime such as, but not limited to, planned downtime, changed planned downtime, unplanned controlled downtime, and planned availability. The planned downtime is agreed in advance, the changed planned downtime has lengthened or shortened duration of the planned downtime period, the unplanned downtime is not agreed in advance and users have little time to prepare for the downtime. The planned availability is agreed in advance and there can be no planned downtimes during planned availability. The technical reasons 250 may represent the technical key for the reason of a downtime.

The data model of runtime 220 includes downtime schedule data object 260 that represents the data model of the downtime schedule, central or local. Since the downtime schedule stores information for system downtimes or system availability, the data model 260 of the downtime schedule shows how this information is represented. The downtime schedule data object 260 includes a number of parameters that define each entry of information stored in the downtime schedule. The parameters may include, but are not limited to, EntryID, Category, MonStatus, DistribStatus, CreatedAt, CreatedBy, ChanagedAt, ChanagedBy, Owner, Component ID, Reason, TechReason, TimestampFrom, and TimestampTo.

“EntryID” specifies the identifier (ID) of each entry in the downtime schedule, as the ID is a global unique identifier (GUID), which is unique in any context. “Category” specifies the type of the downtime, for example, planned downtime, changed planned downtime, unplanned controlled downtime, and planned availability. “MonStatus” specifies the monitoring status of the system, instance, or server node, it can have the following values, but not limited to: suppress incidents—defines that no incidents are created based on alerts from the system; the system status is still available in monitoring tools; suppress monitoring—specifies that a monitoring pause is defined for the system, the system is not delivering any monitoring data; and full monitoring—specifies full monitoring of the system. “DistribStatus” specifies the distribution status of an entry, when distributing the entry from a managing system 110 to managed system 115; the distribution status may take values: failed—the entry is not distributed; success—the entry is distributed; and local—the entry is for the local system only and does not need to be distributed.

“CreatedAt” specifies the date and time when a planned downtime is created. “CreatedBy” specifies the author of the created downtime. “ChangedAt” specifies the date of the last change of a planned downtime. “ChanagedBy” specifies the author of the changed downtime. “Owner” specifies the person initiating or responsible for the downtime. “Reason” specifies the reason of the downtime (e.g., upgrade of a component). “TechReason” specifies a technical key for the downtime reason. “TimestampFrom” and “TimestampTo” define a specific time period for a downtime; if it is a single downtime, the “TimestampFrom” specifies the start date and time of the downtime and the “TimestampTo” specifies the end date and time of the downtime. If the downtime is defined with a recurrence rule, then “TimestampFrom” and “TimestampTo” define the validity period of the rule for the downtime.

The downtime schedule 260 can be referenced by a number of other objects such as target date rule 265 and system landscape (SL) component 270. The target date rule 265 is used for multiple recurrences of a planned downtime (e.g., every first Friday each month). Thus, the target date rule 265 data object has a reference to the downtime schedule data object 260, as there can be defined a rule for a particular entry in the downtime schedule. The central downtime schedule 130A links a managed system 115 to the downtime information stored in the downtime schedule. The managed system 115 can be a system, a server node, or an instance of a system that can be started or stopped. In different environments, system landscape components 270 can be managed differently.

The system landscape components 270 data object includes, but is not limited to, the following parameters: ComponentID, ComponentType, and ComponentKey. Depending on the managed system 115, a system landscape may include different components. In an embodiment, managed system 115 may be an application server having a number of application server instances, each server instance residing on a separate physical machine or on a single machine. In addition, each application sever instance may have a number of server nodes and thus, forming a cluster of server nodes. Further, each server node may have a number of components such as a Web container responsible for presentation logic of any deployed applications, an EJB container responsible for the business logic of the deployed applications, and so on. Therefore, to differentiate, each component in the system landscape is defined with ComponentID, ComponentType, and ComponentKey. “ComponentID” specifies the identification number (ID) of the component, for example, the ID with which a server instance is registered during installation of the system. “ComponentType” specifies the type of the component, for example, application server instance, server node, managed system, etc. “ComponentKey” specifies the technical key of the corresponding component. Component connection data object 275 stores data for the connection between the managing system 110 and managed system 115. The managed system 115 is connected with the managing system via a communication channel, such as a Web service. Component connection object 275 contains the following parameters: ComponentID, LogicalPort, and Destination. “ComponentID” specifies the identification number (ID) of a particular component (e.g., the system ID of managing system 110). “LogicalPort” specifies the logical port to the managed system (e.g., system 115) that will be used to distribute an entry from the central downtime schedule 130A to the local downtime schedule 130B of the managed system 115. “Destination” specifies the client system (e.g., managed system 115) to receive the data entry. Component connection data object 275 has a reference to SL components 270 data to establish a connection between the two systems.

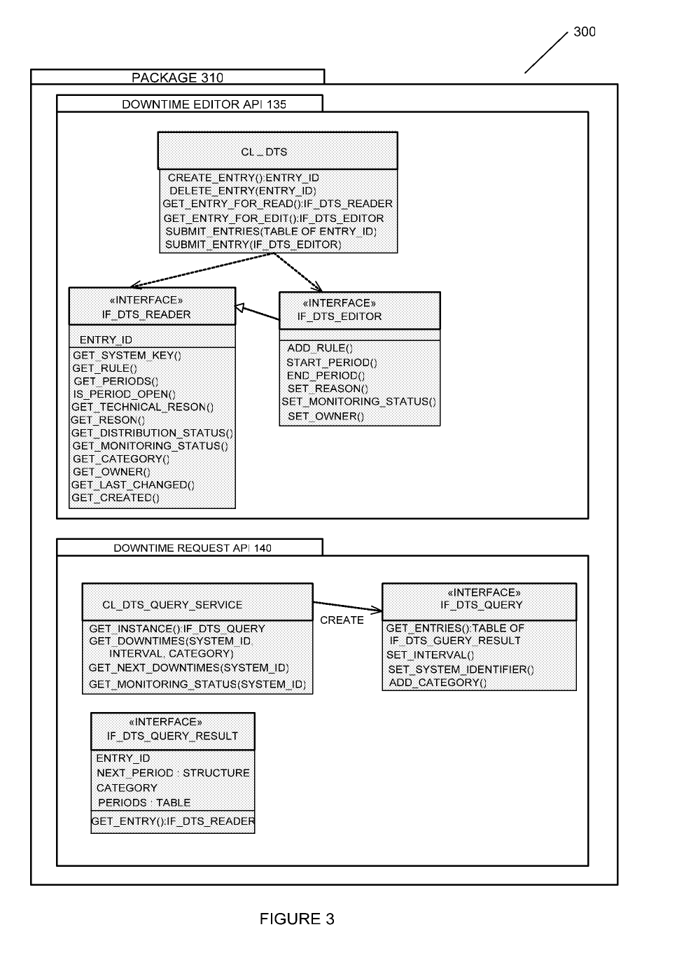

FIG. 3 is a diagram 300 including APIs for editing and querying the downtime schedule. Applications in both the managing system 110 and the managed system 115 have access to the information in the downtime schedule via APIs. In an embodiment, package 310 contains two APIs: downtime editor API 135 and downtime request API 140. The downtime editor API 135 includes methods for creating, editing, and deleting an entry from a local or central downtime schedule, local or central. For each downtime, an entry with the following input parameters can be created: 1) system, server node, or server instance identifier (ID); 2) rule—a rule defining the recurrences of scheduled downtimes during a validity period; 3) category—specifies the type of a downtime (e.g., planned downtime, changed planned downtime, unplanned controlled downtime, and planned availability); 4) reason—a short textual description of the reason for the downtime; 5) technical reason—a technical key for the downtime reason; 6) monitoring status—decides how monitoring and alerting are affected by the downtime, the following monitoring status values are covered: suppress incidents; suppress monitoring; and full monitoring; and 7) logical port—specifies a logical port to the managed system (e.g., system 115). As a result, an entry with global unique identifier (GUID) and distribution status is created indicating if the entry is distributed to the managed system; the distribution status can be failed, success, and local.

The downtime editor API includes a method for editing entries in the central downtime schedule by changing entry's properties. The following properties can be changed: 1) change rule—replaces existing rule or modifies the validity period of the rule; 2) add a new rule—the new rule will replace the old rule if the new rule covers the full validity period of the old rule; otherwise, the validity of the old rule will be adapted to avoid overlapping with the new rule; 3) logical port—the logical port provided during creation of the entry will be used to forward information to the managed system (such as managed system 115); 4) reason; 5) monitoring status; and 6) owner.

The downtime editor API includes a method for reading properties of an entry in the downtime schedule. The following properties can be read: system ID, rule, validity period, technical reason, distribution status, monitoring status, category, owner, created by, changed by, created at, and changed at. The downtime editor API also includes a method for deleting and refreshing entries from the downtime schedule by providing the entry ID as an input parameter. In case of refreshing the entries in the downtime schedule, a table of GUIDs of successful entries and/or failed entries will be returned.

When creating, modifying or deleting an entry in the downtime schedule, only recurrences that occur in the future will be edited. The default behavior for changing the recurrence rule of an existing downtime is to create a new rule for future recurrences and keep the rule for occurrences in the past. The validity period for new rules may only start in the future. A rule can only be deleted if its validity period starts in the future. Otherwise, the rule is adapted so that the validity period ends within the last occurrence in the past. Entries can be created and edited in the central downtime schedule only, thus synchronization problems are avoided.

Package 310 contains a downtime request API 140. The API provides methods in the central managing system 110 and in managed system 115 to retrieve all planned downtime periods within a given time interval and to retrieve the next planned downtime period. The method that retrieves all planned downtime periods within a given time interval accepts as an input parameter the system ID and returns a table of entries, where each entry contains: entry ID and a table of validity periods. The method of the downtime request API 140 that retrieves the next planned downtime period accepts as an input parameter the system ID and returns a period of time defined with an entry ID and a timestamp from a particular time and date and a timestamp to a particular time and date. More information about each entry can be obtained with the read method of the downtime editor API 135.

The API also provides methods only in the central managing system 110 to retrieve all entries for a given set of filter values and to check the monitoring status. The method that checks the monitoring status accepts as input parameters: system ID and monitoring status. The method returns a result that has value: true or false. The method that retrieves all entries for a given set of filter values maps a specific system identifier to the entries in the central downtime schedule. The method accepts as input parameters: system ID filter—a table of system identifiers, category filter—a table of categories, and monitoring status filter—a table of monitoring status values. The method returns a table of entry IDs.

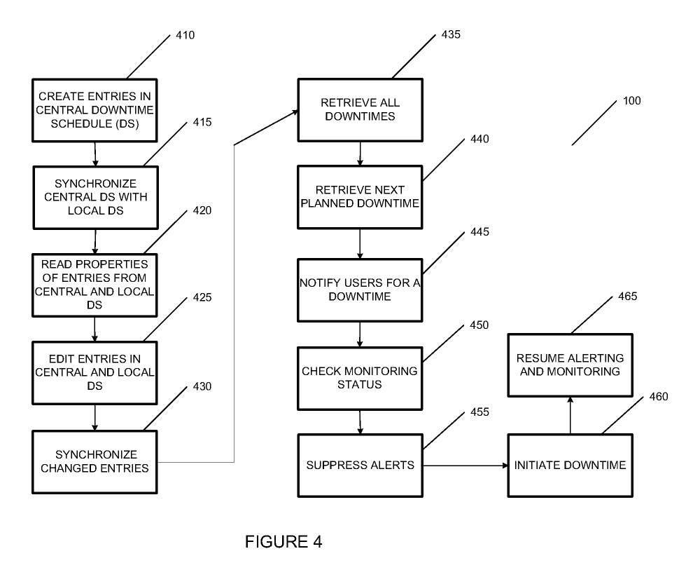

FIG. 4 is a flow diagram of an embodiment for central downtime planning. Central downtime planning is a prerequisite to reduce administrative total cost of ownership (TCO) for large and complex system landscapes. Alerting infrastructures can react on situations of planned downtimes. This prevents creation of incidents in help desk scenarios. Users and other interested parties can be notified timely and automatically about planned, unplanned, or changed downtimes. The central downtime planning also allows customers of a service provider, such as a central managing system, to define periods of time where no planned downtimes are possible. In addition, maintenance planning tools can publish their maintenance intervals in the central schedule.

The central managing system (e.g., system 110) is connected via Web services with a number of managed systems, such as managed system 115. Downtimes for the managed systems are planned in the central downtime schedule of the central system and provided to the local downtime schedule of the respective managed system via a synchronization service. Thus, applications in both the managing system and the managed system have access to the information in the downtime schedule.

Referring to FIG. 4, flow diagram 400 presents the process of planning and initiating a downtime from a central managing system to a managed system. At block 410, entries in the central downtime schedule are created via a method of the downtime editor API. The entries are created with a plurality of properties such as system ID, category, recurrence rule, monitoring status, and so on. (The list of properties along with their descriptions is listed above with respect to FIG. 3.) The created entries correspond to planned downtimes for the managed system. The downtimes are defined as, but not limited to, planned, unplanned, and planned availability. At block 415, data of the entries located in the central downtime schedule is synchronized with the local downtime schedule of the managed system. Thus, the planned downtimes, the unplanned downtimes, and the planned availability periods are available in the managed system as well.

At block 420, a user can read the properties of an entry in the downtime schedule, local or central (as the data in both downtime schedules should be the same after synchronization). For example, the user can check the person that created a particular downtime entry or the category of the downtime. At block 425, a user can edit properties of an entry in the central downtime schedule. For example, the user can change or add a new recurrence rule for a particular downtime. Edit operations are described above with respect to FIG. 3 and the downtime editor API's methods. At block 430, the entries are again synchronized between the central downtime schedule and the local downtime schedule. Thus, if a user has changed some of the properties of an entry in the central managing system (e.g., added a new rule), after a synchronization, the data will be the same in both downtime schedules. At block 435, a particular application (or user) can retrieve all planned downtimes from the downtime schedule to perform its job correctly. For example, the availability reporting application 155 can retrieve all planned downtimes to report periods of unavailability correctly in accordance with an SLA. Thus, the unavailability reports can be automatically generated.

At block 440, an application or a user can retrieve the next planned downtime. Thus, the user can be prepared for the upcoming downtime and backup his or her data in advance. At block 445, a notification tool can notify all users in the managed system for upcoming downtimes. At block 450, the monitoring status for a specific downtime is checked. For a downtime period, the monitoring status can be set to “suppress monitoring”, which will create a monitoring pause for the managed system and no monitoring data will be delivered. Thus, the performance of the downtime tasks will be increased and no unnecessary monitoring data will be delivered during this period. At block 455, alerts in the managed system can be suppressed locally or centrally from the central managing system. Locally, the alerts are suppressed from the local alert engine, such as the CCMS console. Centrally, the alerts are suppressed from the central alert engine, such as the CCMS MTE console. The alert engines check the downtime schedule before creating an alert. If a downtime is in process, then all alerts are suppressed.

At block 460, a downtime is initiated on the managed system. The managed system can be stopped for a downtime locally or centrally. Locally, the system can be stopped from a command line console, an API, or using a script. During the downtime, all alerts, incidents, and monitoring are suppressed. The managed system can be started from a script or from an application that resides on the central managing system. At block 465, monitoring and alerts are automatically resumed on the managed system after the downtime period.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program, which may be transferred from a remote computer (e.g., a server) to a requesting computer (e.g., a client) via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A computerized method comprising:
storing a plurality of entries in a downtime schedule, wherein the downtime schedule can be a central downtime schedule, residing on a managing system, or a local downtime schedule, residing on a managed system;
synchronizing the central downtime schedule with the local downtime schedule; and
querying the downtime schedule to retrieve downtimes of the managed system.

2. The method of claim 1, wherein each entry of the plurality of entries is stored with a plurality of properties.

3. The method of claim 2, wherein the plurality of properties comprises any of the following: a system identifier for the managed system, a rule for recurrence of an entry, a category of the entry, a monitoring status, a reason, and a logical port to be used for forwarding information from the managing system to the managed system, wherein the information regards the plurality of entries.

4. The method of claim 3, wherein the category of the entry defines the entry selected from the group consisting of a planned downtime, an unplanned downtime, and a planned availability period for the managed system.

5. The method of claim 3, wherein the monitoring status has a value selected from the group consisting of suppress incidents, suppress monitoring, and full monitoring.

6. The method of claim 3 further comprising:
modifying a subset of the plurality of properties of a subset of the plurality of entries; and
synchronizing the central downtime schedule with the local downtime schedule in response to editing the subset of the plurality of properties.

7. The method of claim 1 further comprising:
querying the local downtime schedule to retrieve all downtimes of the managed system; and
notifying users of the managed system about an upcoming downtime.

8. The method of claim 6 further comprising:
deleting any number of entries from the plurality of entries from the downtime schedule; and
refreshing any number of entries from the plurality of entries from the downtime schedule.

9. The method of claim 6, wherein editing the subset of the plurality of properties comprises:
changing any of the following: the rule for recurrence, if the recurrence happens in the future, the logical port, the monitoring status, and the reason; and
adding a new rule for recurrence.

10. The method of claim 1, wherein querying the downtime schedule comprises:
retrieving all planned downtimes within a given time period;
retrieving a next planned downtime; and
retrieving the plurality of entries in the downtime schedule.

11. The method of claim 10 further comprising:
generating a set of unavailability reports in response to retrieving the plurality of entries in the downtime schedule;
checking the monitoring status of the managed system; and
suppressing alerts and incidents in response to checking the monitoring status.

12. A computing system comprising:
a central managing system;
a set of managed systems that are connected with the central managing system via a Web service;
a central downtime schedule that stores a plurality of entries, the central downtime schedule residing on the central managing system; and
a synchronization service that synchronizes the plurality of entries stored in the central downtime schedule with a local downtime schedule residing on each of the set of the managed systems.

13. The computing system of claim 12 further comprising:
an application programming interface (API) unit with methods for creating, editing, deleting, and refreshing the plurality of entries; and
an API unit with methods for querying the central downtime schedule and the local downtime schedule.

14. The computing system of claim 12 further comprising:
an availability reporting unit that determines unavailability periods of a managed system;
a notification tool residing on the managed system to send notifications to users about the plurality of entries; and
an availability monitoring unit that evaluates the unavailability periods.

15. The computing system of claim 12 further comprising:
an alert engine that determines when to suppress alerts based on the plurality of entries.

16. The computing system of claim 12 further comprising:
a command line console residing on each of the set of managed systems to start and stop the managed systems locally; and
an application residing on the central managing system to start and stop the managed systems centrally.

17. The computing system of claim 12 further comprising:
an appointment rules unit that includes a set of rules for recurrences of a subset of the plurality of entries.

18. A computer-readable storage medium having instructions therein that when executed by the machine, cause the machine to:
store a plurality of entries in a downtime schedule, wherein the downtime schedule can be a central downtime schedule, residing on a managing system, or a local downtime schedule, residing on a managed system;
synchronize the central downtime schedule with the local downtime schedule; and
query the downtime schedule to retrieve downtimes of the managed system.

19. The computer-readable storage medium of claim 18 having instructions that when executed further cause the machine to:
query the local downtime schedule to retrieve all downtimes of the managed system; and
notify users of the managed system about an upcoming downtime.

20. The computer-readable storage medium of claim 18 having instructions that when executed further cause the machine to:
retrieve all planned downtimes within a given time period;
retrieve a next planned downtime;
check a monitoring status of the managed system; and
retrieve the plurality of entries in the downtime schedule.
